(19) United States
(12) Patent Application Publication
(10) Pub. No.: US 2006/0156318 A1
(43) Pub. Date: Jul. 13, 2006

(54) Optical disk apparatus and a portable information processing apparatus mounting the same therein

(75) Inventors: Toshio Shoji, Urayasu (JP); Takashi Kobune, Hitachinaka (JP); Toshiharu Kon, Matsudo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi - LG Data Storage, Inc., Tokyo (JP)

(21) Appl. No.: 11/034,313

(22) Filed: Jan. 11, 2005

(51) Int. Cl. G11B 33/02

(52) U.S. Cl. 720/600

(57) ABSTRACT

An optical disk apparatus, enabling effective protection from mal functions due to the radio-waves entering inside the apparatus from an outside thereof, comprises a housing 10, a tray 20, which can be inserted/discharged into the housing through an opening portion 12 thereof, a disk motor 50, which is provided in a part of the tray, for driving an optical disk rotationally, an optical pickup 30, which is also provided in a part of the tray, for recording and/or reproducing information with using an optic beam, a signal processing circuit board 40, which is provided in a part of the housing on the other hand, for processing a signal from the optical pickup mounted on the tray, wherein a flexible wiring sheet 100 or 200 is disposed in a part thereof, while being curved, and further an absorbing member 300 or 400 for radio-waves is provided at a position in vicinity of the curved portion 110 or 210, thereby lowering resonances of electromagnetic waves within an inside of the housing, in particular, in the vertical direction thereof.

### BACKGROUND OF THE INVENTION

1. Field of the Invention

The present invention relates to an optical disk apparatus, being able to record/reproduce information upon an optical disk, i.e., an optical information recording medium, such as, a CD-R and/or a CD-RW, etc., for example, with using a semiconductor laser diode, for example, and further relates to a portable-type information processing terminal apparatus applying the same therein.

2. Description of the Related Art

Conventionally, the optical disk apparatus, applying a laser diode therein as a light-generation source thereof, is used widely, in the fields of recording/reproducing music and pictures, in addition to an optical disk for exclusive use of reproducing, such as, a CD-ROM, etc., but also for recording information, as well as, reproducing information, onto/from an optical disk of recordable-type, such as, the CD-R (CD-Recordable) and/or the CD-RW (CD-ReWritable), and a DVD-RAM (Digital Versatile Disc-Random Access Memory), etc., for example. Also, accompanying with an increase in the volume of information to be recordable thereon, as well as, an increase in processing speed thereof, it also comes to be used, more widely, to be an information recording apparatus (i.e., a memory device) in a information processing terminal, such as, a personal computer, etc., for example.

Also, upon such the optical disk apparatus, small-sizing is also achieved, remarkably, and in particular, accompanying with spread of a small-sized and portable personal computer (for example, a notebook-sized personal computer, etc.), an optical disk apparatus of a type, being light/thin, is strongly demanded and is also actually practiced, such that it can be mounted into such the portable-type information processing terminal.

On the other hand, also a manner of using such the optical disk apparatus mentioned above changes, greatly, together with such the lightweight/thinning thereof, and in particular, accompanying with swift spread thereof in recent years, there can be found many cases where a user operates the portable-type personal computer while using a portable telephone apparatus, at the same time. Namely, in many cases, the optical disk apparatus is used close vicinity to equipment, which generates radio-waves therefrom; however, the radio-waves (i.e., electromagnetic waves) of 940 MHz and/or 1.44 GHz, being generated from such the portable telephone apparatus, is/are obstructing or jamming waves to the said disk apparatus. Thus, if it enters into the apparatus to be mixed onto wiring provided therein, then it may cause an abnormal operation, such as, read-error, seek-error, etc., for example.

By the way, within such the disk deriving apparatus, a dustproof cap is already known, in Japanese Patent-Laying Open No. Hei 10-125054 (1998) <Patent Document 1>, for example, of preventing dusts from adhering onto the circuit board, certainly, as well as, having a superior shielding to the noises of electromagnetic waves, and further protecting it from electrification due to electrostatics.

### SUMMARY OF THE INVENTION

With such the conventional technology, i.e., the dustproof cap described in the Patent Document 1 mentioned above, only covering over the devices, which may causes malfunctions therein, by means of a metal material having electric conductivity, however, it has a drawback that an effect cannot be obtained, fully, in particular, against the electromagnetic waves of 940 MHz and/or 1.44 GHz, being generated from such the portable telephone apparatus.

By the way, the inventors of the present invention found or discovered the following facts upon the basis of various experiments made by them, in particular, upon such the optical disk apparatus of light/thin type, which can be also mounted on the portable-type information processing terminal, as was mentioned above, however due to the structure thereof, and the present invention was accomplished such the facts discovered by the inventors.

Thus, with such the light/thin type optical disk apparatus, which can be mounted onto the portable-type information processing terminal mentioned above, there is widely applied such the structure, wherein so-called the tray can slide into an inside of the plate-like housing (or a cover) by the function of so-called a transmitting mechanism, to be discharged into an outside from an opening formed on a front surface of the housing, or inserted into the inside thereof. And, on that tray are mounted an optical pickup for recording/reproducing information onto/from the rotating optical disk through the laser beam, as well as, a disk motor for driving the optical disk mounted on a rotation shaft thereof, rotationally. On the other hand, within an inside of that cover mentioned above, there are provided a signal processing portion for processing a signal from that optical pickup or for producing a control signal or the like for controlling thereof. And, wiring is obtained with using a wiring sheet (i.e., FPC: Flexible Printed Circuit) having flexibility, between the cover and the tray, which are movable to each other in the positions thereof. And, the optical pickup is also movable in the radial direction of the optical disk, therefore there is also used or applied such the wiring sheet having flexibility in the wiring thereof.

However, such the obstructive or jamming electromagnetic waves entering into the optical disk apparatus has a directional property. Then, for example, in a case where a radio-wave generator, such as, the portable telephone apparatus, for example, is located near to an opening portion (i.e., a front bezel) of the optical disk apparatus, in other words, where the radio-waves enter therein in the direction, being nearly perpendicular to the optical disk apparatus, then almost of those are reflected on an inner surface of the housing (i.e., the cover) building up an outer configuration of the optical disk apparatus. However, the electromagnetic waves will not distinguish due to such the reflection thereof, but they only change the direction thereof. Also, the housing of the optical disk apparatus is made, in general, of a metal, such as, iron or aluminum, etc., and then depending upon the frequency of radio-waves entering therein, they are reflected, to generate resonances within the housing, thereby amplifying the strength of the radio-waves. And, it is found that mixing of noises due to such a phenomenon of the resonances (i.e., noise resonances) is remarkable upon the wiring sheet having such the flexibility as was mentioned above, and in particular, the curved portion thereof. Namely, a portion extending in almost parallel to the resonating radio-waves can easily receive the ill influences thereof, at the most. It can be considered, this is caused due to the fact that the direction of the wiring is coincident with that of the resonance of the radio-waves, i.e., in the direction of thickness of the housing (i.e., the cover), in particular in the curved portion of the wiring sheet having flexibility mentioned above.

Then, according to the present invention, upon the basis of such the discovery of the present inventors, an object thereof is to provide an optical disk apparatus, which can effectively protecting from mal functions due to the radio-waves entering inside the apparatus from an outside thereof, in particular, due to the noise radio-waves from such the portable telephone apparatus, and further to provide a portable information processing apparatus mountains such the optical disk apparatus therein.

For accomplishing such the object mentioned above, according to the present invention, first of all, there is provided an optical disk apparatus, comprising: a housing being nearly plate-like, having an opening portion opened in a part thereof; a tray being stored within an inside of said housing and able to be inserted/discharged through said opening portion; a disk motor provided in a part of said tray, being able to mount a disk-like optical information recording medium on a rotation shaft thereof and to rotate therearound; an optical pickup provided in a part of said tray, for recording and/or reproducing information with using an optic beam onto/from said disk-like optical information recording medium; and a signal processing portion provided in a part of said housing, for processing a signal from said optical pickup mounted on said tray, wherein a flexible wiring sheet is disposed, at least in a portion thereof, while being curved, and further an absorbing member for radio-waves is provided at a position in vicinity of the curved portion of said flexible wiring sheet.

Also, according to the present invention, within the optical disk apparatus as described in the above, preferably, the curved portion of said flexible wiring sheet has a portion extending in a direction, being nearly perpendicular to upper and lower surfaces of said nearly plate-like housing, and further said flexible wiring sheet is a flexible wiring sheet for obtaining wiring between said signal processing portion, which is disposed within an inside of said housing, and said tray being able to be inserted/discharged through the opening portion of said housing. Or, alternatively, it is preferable that said flexible wiring sheet is a flexible wiring sheet for obtaining wiring between said tray and said optical pickup, which is disposed to be movable to said tray. And, in addition thereto, it is preferable that said absorbing member for radio-waves is sheet-like, and it is stick at the position in vicinity of said curved portion.

Also, according to the present invention, said optical disk apparatus is attached onto a part of a portable-type information processing apparatus, or is a portable-type information processing apparatus mounting the optical disk apparatus as described in the above into an inside thereof.

### BRIEF DESCRIPTION OF THE DRAWINGS

Those and other objects, features and advantages of the present invention will become more readily apparent from the following detailed description when taken in conjunction with the accompanying drawings wherein:

FIG. 1 is a perspective view for showing the entire structure of an optical disk apparatus from the above thereof, according to one embodiment of the present invention;

FIG. 2 is a perspective view for showing the optical disk apparatus mentioned above, according to the present invention, in particular, the structure of a tray portion from the beneath thereof;

FIG. 3 is a view for explaining behavior of obstructive or jamming radio-waves (electromagnetic waves) within the optical disk apparatus mentioned above, according to the present invention; and

FIG. 4 is a view for showing an example of the condition where the optical disk apparatus according to the present invention is built into a portable information processing apparatus, such as, a notebook-type personal computer, for example.

### DESCRIPTION OF THE PREFERRED EMBODIMENTS

Hereinafter, embodiments according to the present invention will be fully explained by referring to the attached drawings.

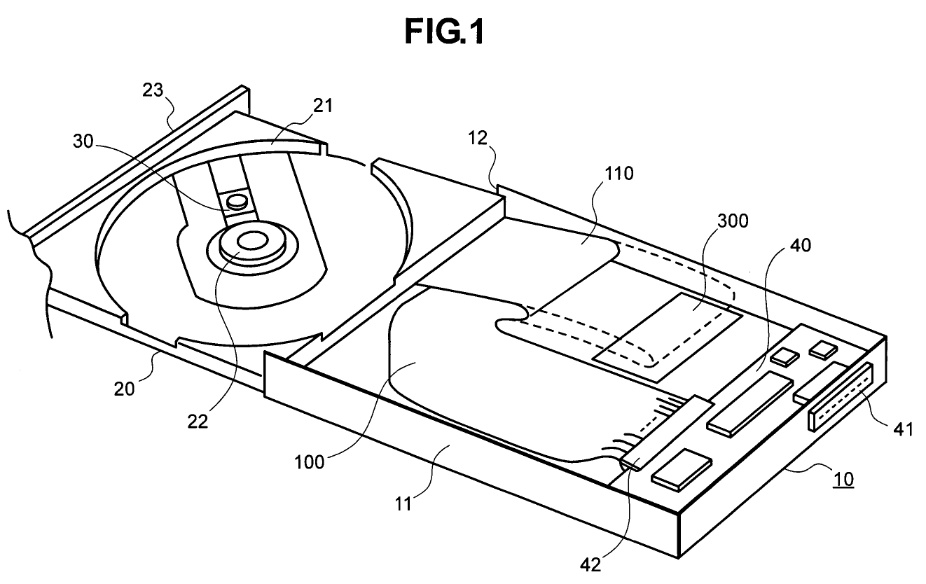

First of all, FIG. 1 attached herewith is a perspective view for showing the entire structure of an optical disk apparatus, according to one embodiment of the present invention. However, this figure shows the condition where the apparatus is viewed from the above while removing a top cover thereof, for showing the internal structure thereof.

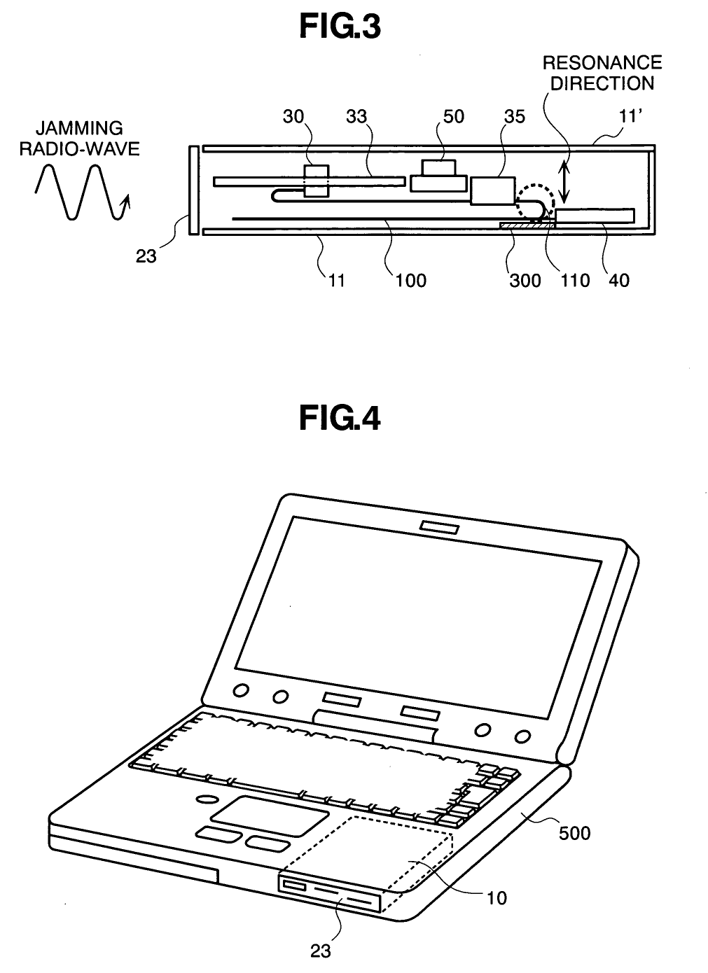

In this figure, an opening portion 12 is formed in a bottom cover 11, which builds up a portion of a housing having a shape of about plate-like configuration, together with the top cover not shown in this figure (but, see a reference numeral 11′ in FIG. 3), in particular, on a front-side surface thereof (see the left-hand side in the figure), and within an inside of this housing 10 is stored or contained so-called a tray 20, i.e., a member for mounting a disk-like optical information recording medium, such as, a DC, for example, on an upper surface thereof. Further, this tray 20 can be discharged into an outside of the housing 10 or inserted into an inside thereof, from the opening portion 12 due to the function of a feeding mechanism not shown in the figure herein. Also, upon the upper-side surface of this tray 20, as is shown in the figure, there is formed a recess portion 21, for inserting the CD therein, and also at about a central portion thereof is provided a turntable 22, being attached at a tip of the rotation shaft of a disk motor, the details of which will be also explained below. Namely, in a case when inserting the optical disk, such as, the CD, etc., for example, into this optical disk apparatus, this tray 20 is drawn out into an outside of the housing 10, through pushing down a button not shown in the figure, etc., for example, then the optical disk is inserted into a circular opening portion formed within an inside of the tray at the outer periphery thereof, and thereafter, the optical disk is inserted into an inside of the housing 10 together with that tray 20.

Also, on the tray 20 mentioned above, there is provided so-called an optical pickup 30, i.e., a member for irradiating a laser beam onto the optical disk attached and rotated at high speed on the turntable 22, thereby writing information onto the information recording surface thereof or reproducing information written thereon through a reflection light, being freely movable into a radial direction of the optical disk (sown by an arrow in the figure). Further, a reference numeral 23 in the figure depicts so-called a front bezel, covering over the opening portion 12 in the front surface of the housing 10 mentioned above.

On the other hand, within the housing 10 are formed a space, being receivable the tray 20 mentioned above into an inside thereof, and also around this receiving space, there is mounted so-called a processing circuit board 40, for processing various kinds of signals, which are detected by the optical pickup 30 disposed on the side of the tray 20 and converted into the electric signals. Further, on the reverse-side surface of the housing 10 is provided an interface 41 for connecting this optical apparatus to an outside apparatus, such as, a personal computer, etc., thereby transmitting the signals (i.e., information), which are detected from the optical disk through the optical pickup 30 and processed within the processing circuit board 40, into an outside thereof, or writing the signals (i.e., information) onto the optical disk, which are transmitted from the outside thereof.

And, within a small-sized and light-weighted optical disk apparatus of portable-type, having such the structure as was mentioned above, for the purpose of achieving electrical connection between the tray 20, which mounts the disk motor and the optical pickup 30, etc., on a part thereof, being slidably insertable/dischargable into/from the hosing 10, and the housing 10, there is applied or used so-called a flexible printed circuit sheet (i.e., FPC) 100, being called by “flexible sheet”, in a “U”-like shape thereof. Namely, as is shown in the figure, the “U” shaped flexible sheet 100 is connected to a terminal connector portion 42 formed on the processing circuit board 40, at one end portion thereof, while being fixed the lower surface thereof onto an inner surface of a bottom cover 1 building up the housing 10 via an adhesive, or the like.

And, other portion of the “U” shaped flexible sheet 100 mentioned above is curved into the reverse direction, without being fixed at the lower surface thereof, and the other end thereof is connected to a terminal connector portion, not shown in the figure, which is provided on the tray 20. Thus, this “U” shaped flexible sheet 100, as is shown by broken lines in the figure, moves the position of curved portion 110 thereof depending upon the position moved accompanying with insertion/discharging of the tray 20; thereby, maintaining the electrical connection between the housing 10 and the tray 20, which can change the relative positions therebetween.

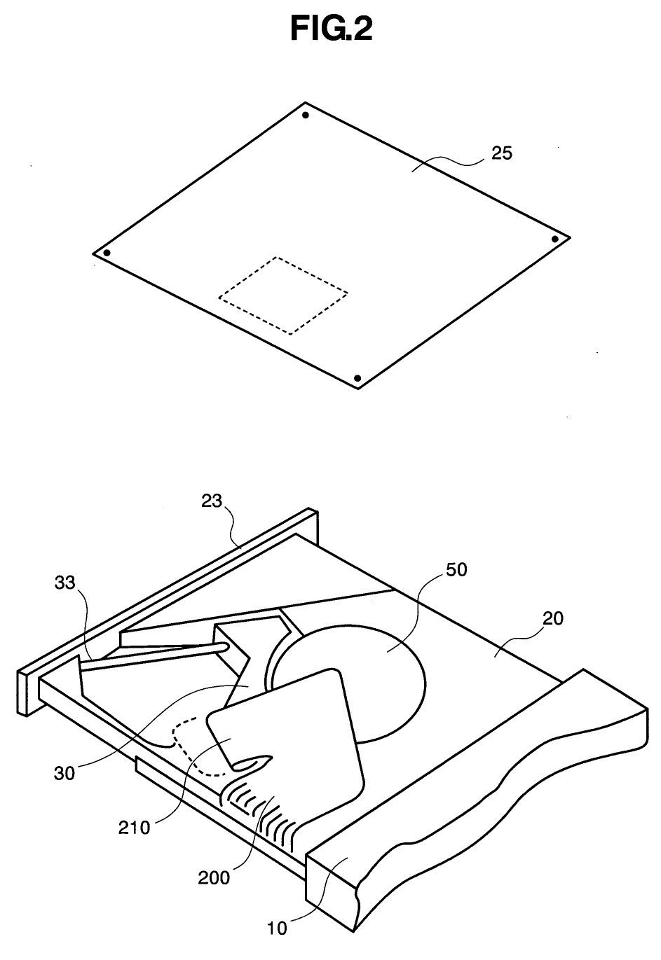

Next, in FIG. 2 attached herewith shows a perspective view of the optical disk apparatus, the entire structure of which was shown in the above, in particular the tray 20 mentioned above, being viewed from the downward thereof. Further, also in this figure, the tray 20 is shown under the condition that the undercover 25 of metal-made attached on the lower surface thereof is taken out, for the purpose of showing the internal structure thereof.

As is apparent from this FIG. 2, around the center of the tray 20 is disposed the disk motor 50 for rotationally driving the optical disk mounted thereon, as was mentioned above, and further, there is mounted a feeding mechanism for shifting the optical pickup 30 into the radial direction of the optical disk, freely. In this figure, although only one sliding shaft 33 is shown, which builds up the feeding mechanism of the optical pickup 30, however it is needless to say that this feeding mechanism further includes therein, not only that feeding mechanism, but also a motor for generating a force of moving the optical pickup 30 and a controller device for it (such as, a motor driver circuit board 35, see FIG. 3), etc.

And also, in the structure of the tray shown in this FIG. 2, for achieving the electrical connection between the optical pickup 30 being freely movable in the position thereof to the tray 20, there is also applied or used so-called a flexible printed circuit sheet (i.e., FPC) 200, being called by “flexible sheet”, in a “U”-like shape thereof. Thus, as is shown in the figure, the “U” shaped flexible sheet 200 is connected to a terminal connector portion not shown in the figure, which is formed on the tray 20, at one end portion thereof, while being fixed the lower surface thereof onto an reverse surface of the tray 20 via an adhesive or the like. Further, the other portion is curved into the reverse direction, without being fixed the lower surface thereof, and the end portion thereof is connected to a terminal connector portion not shown in the figure, which is provided on the optical pickup 30. Thus, this “U” shaped flexible sheet 200 moves the curved portion 210 thereof depending upon the moving position of the optical pickup 30, thereby maintaining the electrical connection between the optical pickup 30 and the tray 20, which can change the relative positions therebetween.

Further, such the small-sized and light-weighted optical disk apparatus of portable type as was mentioned above is attached on a portion (for example, on an outside), or built within an inside of a portable-type information processing apparatus 500, such as, a portable-type personal computer, for example, typically, (the figure shows the built-in optical disk apparatus, with the housing 10 and the bezel 23 thereof), thereby to be used as an information recording/reproducing apparatus thereof. And, on the mode or condition of using thereof, there are many cases where the optical disk apparatus is used in the vicinity of an equipment of generating radio-waves thererom, such as a portable telephone apparatus, etc., and in such the cases, the radio-waves (i.e., the electromagnetic waves) of 940 MHz and/or 1.44 GHz generated from such the portable telephone apparatus penetrate through the bezel 23 thereof, thereby entering into an inside of the optical disk apparatus, to be obstructive or jamming radio-waves. Namely, if they are mixed onto the wiring within the apparatus, then it may be a cause of resulting the abnormal operation, such as, the read-error, the seek-error, etc.

By the way, within such the small-sized and light-weighted optical disk apparatus of portable-type as was mentioned above, such the obstructive or jamming radio-wave (i.e., the electromagnetic wave) as was mentioned above has a directional property, as is shown in FIG. 3 attached. Then, if the radio-wave generator, such as the portable telephone apparatus, comes to be close to the opening portion 23 of the optical disk apparatus (i.e., the front bezel thereof); i.e., the radio-wave in the direction about perpendicular to the optical disk apparatus enters therein, then almost of that is reflected upon an inner surface of the bottom cover 11 and the top cover 11′, which build up the housing 10. However, due to that reflection, the electromagnetic wave does not distinguish, but it change the direction of propagation thereof. Also, the housing 10 of the optical disk apparatus, in general, is made of a metal, such as, iron or aluminum, etc.; therefore, it may generates a resonance within the housing depending upon the frequency of the radio-wave, thereby amplifying the strength of the radio-wave.

And, the mixture of noises due to this phenomenon of resonance (i.e., a noise resonance) is remarkable on the wiring sheet having the flexibility mentioned above, in particular, the curved portion thereof, as was mentioned above. Namely, upon the “U” shaped flexible sheet 100 provided on the housing 10, the phenomenon is remarkable at the position of the curved portion 110 thereof, and also upon the “U” shaped flexible sheet 200 provided on the tray 20, is remarkable at the curved portion 210 thereof. However, it can be considered, such the phenomenon is caused due to the fact that the direction of wiring is coincident with that of the resonance of the ratio-waves at the curved portion of the flexible sheet, i.e., the wiring sheet.

Then, according to the present invention, for protecting the optical disk apparatus from the problem mentioned above, i.e., the abnormal operations, such as, the read-error, the seek-error, etc., which are caused due to the mixture of the radio-waves (i.e., the electromagnetic waves) generated from the portable telephone apparatus or the like, into the optical disk apparatus, absorption members of the electromagnetic waves are provided in the portions, where the direction of wiring comes to be coincident with the direction of the resonance within an inside of the housing of the apparatus; namely, in the vicinity the curved portion 110 of the “U” shaped flexible sheet 100 provided on the housing 10, and further the curved portion 210 of the “U” shaped flexible sheet 200 provided on the tray 20, respectively, for lowering or reducing the resonance of the radio-waves (i.e., the electromagnetic waves).

Further, herein as an example of the absorption member of electromagnetic waves is a metal foil, such as, of copper, etc., for example, being pasted on a sheet-like material, such as, a polyester sheet or the like, for example. And, this sheet, being the absorbing member of electromagnetic waves, is cut out therefrom, into a size, so that it can cover that curved portion, and it is fixed through sticking it with using an adhesive, etc. In more details thereof, in the case of the “U” shaped flexible sheet 100 provided on the housing 10, as is shown by a reference numeral 300 in FIG. 1 mentioned above, the absorption sheet of electromagnetic waves is attached at the portion where the said curved portion will locate under the condition when the tray 20 is inserted into the inside of the housing 10.

This is because, in general, the optical disk apparatus performs the recording/reproducing operation thereof, only under the condition that the tray 20 is inserted into the housing 10; therefore, it is sufficient that the absorption sheet 300 is located only at the position of the “U” shaped flexible sheet 100 where the curved portion 110 is produced under such the condition. Also, in the example shown in this FIG. 1, there is shown an example, where only the absorption sheet 300 is provided only the inner surface side of the bottom cover 11, among the bottom cover 11 and the top cover 11′ building up the housing 10, however the present invention should not be restricted only to that mentioned above. Namely, the absorption sheet may be attached on the inner surface side of the top cover 11′ opposing thereto, and in this case, though increasing the const of attaching thereof, but there can be expected an effect of absorbing the electromagnetic waves, being large much more.

Further, in a case when attaching the sheet of absorbing the electromagnetic waves on a side of the tray 20 shown in FIG. 2 mentioned above, also the sheet of absorbing the electromagnetic waves is cut out into such a size, that it can cover the curved portion 210 of the “U” shaped flexible sheet 200, which is provided between the optical pickup 30 and the tray 20, and it is fixed through sticking with using the adhesive, etc. In more details, as shown by a reference numeral 400 in FIG. 2 mentioned above, the absorption sheet of electromagnetic waves is attached, so that it can cover all over the region where the optical pickup 30 moves; i.e., so as to fully cover the said curved portion 210 that also moves when the optical pickup moves from the outermost periphery to the innermost periphery. This is because, in general, the optical pickup 30 is always moving, freely, in the radial direction of the optical disk, when the optical disk apparatus performs the recording/reproducing operation thereof. Also, in the example in this FIG. 2, the absorption sheet 400 of electromagnetic waves is attached onto an inner surface of the under cover 25, which will be attached on the lower portion of the tray 20 after the “U” shaped flexible sheet 200 is attached thereto.

Thus, according to the present invention, there can be obtained a superior effect that there is provided an optical disk apparatus, which can effectively protecting from mal functions due to the radio-waves entering inside the apparatus from an outside thereof, in particular, due to the noise radio-waves from such the portable telephone apparatus, as well as, providing a portable information processing apparatus mountains such the optical disk apparatus therein.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. An optical disk apparatus, comprising:
a housing being nearly plate-like, having an opening portion opened in a part thereof;
a tray being stored within an inside of said housing and able to be inserted/discharged through said opening portion;
a disk motor provided in a part of said tray, being able to mount a disk-like optical information recording medium on a rotation shaft thereof and to rotate therearound;
an optical pickup provided in a part of said tray, for recording and/or reproducing information with using an optic beam onto/from said disk-like optical information recording medium; and
a signal processing portion provided in a part of said housing, for processing a signal from said optical pickup mounted on said tray, wherein
a flexible wiring sheet is disposed, at least in a part thereof, while being curved, and further an absorbing member for radio-waves is provided at a position in vicinity of the curved portion of said flexible wiring sheet.

2. The optical disk apparatus, as described in the claim 1, wherein the curved portion of said flexible wiring sheet has a portion extending in a direction, being nearly perpendicular to upper and lower surfaces of said nearly plate-like housing.

3. The optical disk apparatus, as described in the claim 1, wherein said flexible wiring sheet is a flexible wiring sheet for obtaining wiring between said signal processing portion, which is disposed within an inside of said housing, and said tray being able to be inserted/discharged through the opening portion of said housing.

4. The optical disk apparatus, as described in the claim 2, wherein said flexible wiring sheet is a flexible wiring sheet for obtaining wiring between said signal processing portion, which is disposed within an inside of said housing, and said tray being able to be inserted/discharged through the opening portion of said housing.

5. The optical disk apparatus, as described in the claim 1, wherein said flexible wiring sheet is a flexible wiring sheet for obtaining wiring between said tray and said optical pickup, which is disposed to be movable to said tray.

6. The optical disk apparatus, as described in the claim 2, wherein said flexible wiring sheet is a flexible wiring sheet for obtaining wiring between said tray and said optical pickup, which is disposed to be movable to said tray.

7. The optical disk apparatus, as described in the claim 1, wherein said absorbing member for radio-waves is sheet-like, and it is stick at the position in vicinity of said curved portion.

8. The optical disk apparatus, as described in the claim 1, wherein said optical disk apparatus is attached onto a part of a portable-type information processing apparatus.

9. The optical disk apparatus, as described in the claim 2, wherein said optical disk apparatus is attached onto a part of a portable-type information processing apparatus.

10. The optical disk apparatus, as described in the claim 3, wherein said optical disk apparatus is attached onto a part of a portable-type information processing apparatus.

11. The optical disk apparatus, as described in the claim 4, wherein said optical disk apparatus is attached onto a part of a portable-type information processing apparatus.

12. The optical disk apparatus, as described in the claim 5, wherein said optical disk apparatus is attached onto a part of a portable-type information processing apparatus.

13. The optical disk apparatus, as described in the claim 6, wherein said optical disk apparatus is attached onto a part of a portable-type information processing apparatus.

14. The optical disk apparatus, as described in the claim 7, wherein said optical disk apparatus is attached onto a part of a portable-type information processing apparatus.

15. A portable-type information processing apparatus mounting the optical disk apparatus as described in the claim 1 into an inside thereof.
